(19) United States
(12) Patent Application Publication
(10) Pub. No.: US 2022/0129931 A1
(43) Pub. Date: Apr. 28, 2022

(54) QUANTIFYING USAGE OF ROBOTIC PROCESS AUTOMATION RELATED RESOURCES

(71) Applicant: UiPath, Inc., New York, NY (US)

(72) Inventors: Tarek MADKOUR, Sammamish, WA (US); Umesh AMIN, Redmond, WA (US)

(73) Assignee: UiPath, Inc., New York, NY (US)

(21) Appl. No.: 17/076,833

(22) Filed: Oct. 22, 2020

(51) Int. Cl. G06Q 30/02; G06Q 10/04; G05B 19/418

(52) U.S. Cl. CPC G06Q 30/0206; G05B 19/4183; G05B 19/41865; G06Q 10/04

(57) ABSTRACT

Systems and methods for consumption based billing for RPA (robotic process automation) are provided. Usage of RPA related resources by a user is quantified based on RPA execution data associated with the user. A bill for the user is generated based on the quantified usage of RPA related resources. The generated bill is output.

### TECHNICAL FIELD

The present invention relates generally to robotic process automation (RPA), and more particularly to quantifying usage of RPA related resources.

### BACKGROUND

Robotic process automation (RPA) is a form of process automation that uses software robots to automate workflows. RPA may be implemented by RPA providers for RPA customers to automate repetitive and/or labor-intensive tasks to reduce costs and increase efficiency. Traditionally, RPA customers are billed by RPA providers based on fixed fee subscription models. For example, RPA customers are traditionally billed for RPA based on yearly or monthly subscription packages. Under such traditional approaches, RPA customers are charged a fixed amount for access to a particular number of RPA robots, even if those RPA robots are not fully utilized. Conventional methods are not able to quantify usage of RPA related resources and therefore do not provide flexibility to enable customers to pay for RPA based on consumption of RPA related resources.

### BRIEF SUMMARY OF THE INVENTION

In accordance with one or more embodiments, systems and methods for consumption based billing for RPA (robotic process automation) are provided. Usage of RPA related resources by a user is quantified based on RPA execution data associated with the user. A bill for the user is generated based on the quantified usage of RPA related resources. The generated bill is output.

In one embodiment, usage of RPA related resources by a user is quantified by calculating one or more parameters representing the usage of RPA related resources based on the RPA execution data. In one embodiment, the one or more parameters may be based on at least one of a compute cycle, CPU (central processing unit) usage, RAM (random access memory usage), storage parameters, or API (application programming interface) usage for RPA services. In another embodiment, the one or more parameters may be based on data sent and received on a network interface. In another embodiment, the one or more parameters may be based on at least one of a number of RPA robots utilized, a type of the RPA robots utilized, an execution of the RPA robots utilized, a number of times an RPA service or task is performed, or metrics evaluating RPA execution. In another embodiment, the one or more parameters includes whether an RPA service or task is a third-party RPA service or task.

In one embodiment, the bill for the user is generated based on a billing model.

In one embodiment, the RPA execution data associated with the user is from at least one of an RPA robot or an RPA orchestrator. The at least one of the RPA robot or the RPA orchestrator may be implemented in a cloud computing environment.

These and other advantages of the invention will be apparent to those of ordinary skill in the art by reference to the following detailed description and the accompanying drawings.

### BRIEF DESCRIPTION OF THE DRAWINGS

FIG. 1 is an architectural diagram illustrating a robotic process automation (RPA) system, according to an embodiment of the invention;

FIG. 2 is an architectural diagram illustrating an example of a deployed RPA system, according to an embodiment of the invention;

FIG. 3 is an architectural diagram illustrating a simplified deployment example of a RPA system, according to an embodiment of the invention;

FIG. 4 shows an architecture diagram illustrating a cloud RPA system for implementing cloud-based management of robotic process automation robots, according to an embodiment of the invention;

FIG. 5 shows a system for consumption based billing for RPA, according to an embodiment of the invention;

FIG. 6 a method for consumption based billing for RPA, according to an embodiment of the invention; and

FIG. 7 is a block diagram of a computing system according to an embodiment of the invention.

### DETAILED DESCRIPTION

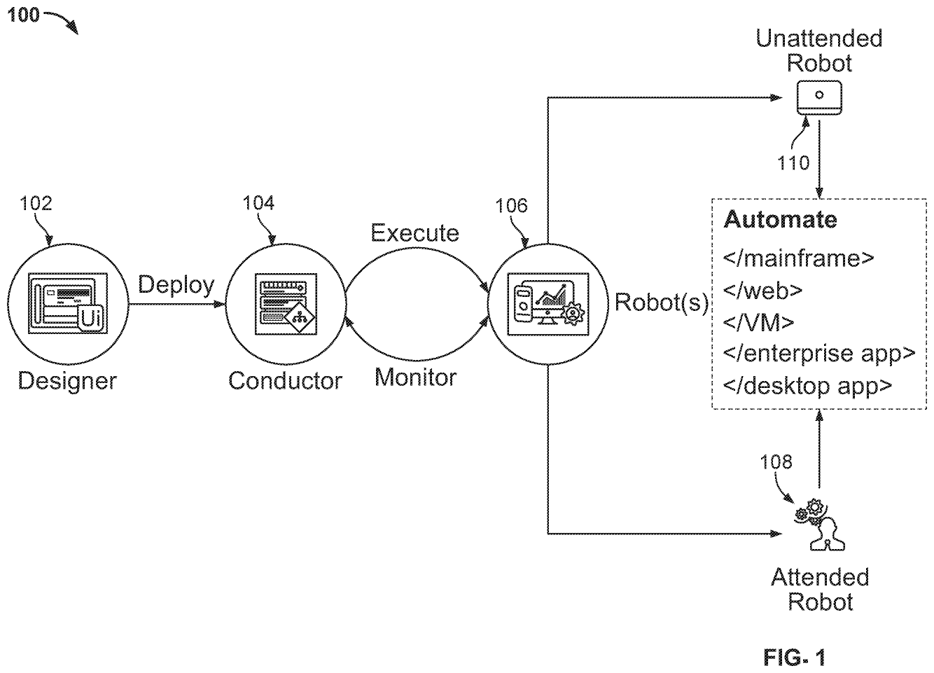

Robotic process automation (RPA) is used for automating workflows and processes. FIG. 1 is an architectural diagram of an RPA system 100, in accordance with one or more embodiments. As shown in FIG. 1, RPA system 100 includes a designer 102 to allow a developer to design automation processes. More specifically, designer 102 facilitates the development and deployment of RPA processes and robots for performing activities in the processes. Designer 102 may provide a solution for application integration, as well as automating third-party applications, administrative Information Technology (IT) tasks, and business processes for contact center operations. One commercial example of an embodiment of designer 102 is UiPath Studio™.

In designing the automation of rule-based processes, the developer controls the execution order and the relationship between a custom set of steps developed in a process, defined herein as “activities.” Each activity may include an action, such as clicking a button, reading a file, writing to a log panel, etc. In some embodiments, processes may be nested or embedded.

Some types of processes may include, but are not limited to, sequences, flowcharts, Finite State Machines (FSMs), and/or global exception handlers. Sequences may be particularly suitable for linear processes, enabling flow from one activity to another without cluttering a process. Flowcharts may be particularly suitable to more complex business logic, enabling integration of decisions and connection of activities in a more diverse manner through multiple branching logic operators. FSMs may be particularly suitable for large workflows. FSMs may use a finite number of states in their execution, which are triggered by a condition (i.e., transition) or an activity. Global exception handlers may be particularly suitable for determining workflow behavior when encountering an execution error and for debugging processes.

Once a process is developed in designer 102, execution of business processes is orchestrated by a conductor 104, which orchestrates one or more robots 106 that execute the processes developed in designer 102. One commercial example of an embodiment of conductor 104 is UiPath Orchestrator™. Conductor 220 facilitates management of the creation, monitoring, and deployment of resources in an RPA environment. In one example, conductor 104 is a web application. Conductor 104 may also function as an integration point with third-party solutions and applications.

Conductor 104 may manage a fleet of RPA robots 106 by connecting and executing robots 106 from a centralized point. Conductor 104 may have various capabilities including, but not limited to, provisioning, deployment, configuration, queueing, monitoring, logging, and/or providing interconnectivity. Provisioning may include creation and maintenance of connections between robots 106 and conductor 104 (e.g., a web application). Deployment may include assuring the correct delivery of package versions to assigned robots 106 for execution. Configuration may include maintenance and delivery of robot environments and process configurations. Queueing may include providing management of queues and queue items. Monitoring may include keeping track of robot identification data and maintaining user permissions. Logging may include storing and indexing logs to a database (e.g., an SQL database) and/or another storage mechanism (e.g., ElasticSearch®, which provides the ability to store and quickly query large datasets). Conductor 104 may provide interconnectivity by acting as the centralized point of communication for third-party solutions and/or applications.

Robots 106 are execution agents that run processes built in designer 102. One commercial example of some embodiments of robots 106 is UiPath Robots™. Types of robots 106 may include, but are not limited to, attended robots 108 and unattended robots 110. Attended robots 108 are triggered by a user or user events and operate alongside a human user on the same computing system. Attended robots 108 may help the human user accomplish various tasks, and may be triggered directly by the human user and/or by user events. In the case of attended robots, conductor 104 may provide centralized process deployment and a logging medium. In certain embodiments, attended robots 108 can only be started from a “robot tray” or from a command prompt in a web application. Unattended robots 110 operate in an unattended mode in virtual environments and can be used for automating many processes, e.g., for high-volume, back-end processes and so on. Unattended robots 110 may be responsible for remote execution, monitoring, scheduling, and providing support for work queues. Both attended and unattended robots may automate various systems and applications including, but not limited to, mainframes, web applications, VMs, enterprise applications (e.g., those produced by SAP®, SalesForce®, Oracle®, etc.), and computing system applications (e.g., desktop and laptop applications, mobile device applications, wearable computer applications, etc.).

In some embodiments, robots 106 install the Microsoft Windows® Service Control Manager (SCM)-managed service by default. As a result, such robots 106 can open interactive Windows® sessions under the local system account, and have the rights of a Windows® service. In some embodiments, robots 106 can be installed in a user mode with the same rights as the user under which a given robot 106 has been installed.

Robots 106 in some embodiments are split into several components, each being dedicated to a particular task. Robot components in some embodiments include, but are not limited to, SCM-managed robot services, user mode robot services, executors, agents, and command line. SCM-managed robot services manage and monitor Windows® sessions and act as a proxy between conductor 104 and the execution hosts (i.e., the computing systems on which robots 106 are executed). These services are trusted with and manage the credentials for robots 106. A console application is launched by the SCM under the local system. User mode robot services in some embodiments manage and monitor Windows® sessions and act as a proxy between conductor 104 and the execution hosts. User mode robot services may be trusted with and manage the credentials for robots 106. A Windows® application may automatically be launched if the SCM-managed robot service is not installed. Executors may run given jobs under a Windows® session (e.g., they may execute workflows) and they may be aware of per-monitor dots per inch (DPI) settings. Agents may be Windows® Presentation Foundation (WPF) applications that display the available jobs in the system tray window. Agents may be a client of the service. Agents may request to start or stop jobs and change settings. Command line is a client of the service and is a console application that can request to start jobs and waits for their output. Splitting robot components can help developers, support users, and enable computing systems to more easily run, identify, and track what each robot component is executing. For example, special behaviors may be configured per robot component, such as setting up different firewall rules for the executor and the service. As a further example, an executor may be aware of DPI settings per monitor in some embodiments and, as a result, workflows may be executed at any DPI regardless of the configuration of the computing system on which they were created.

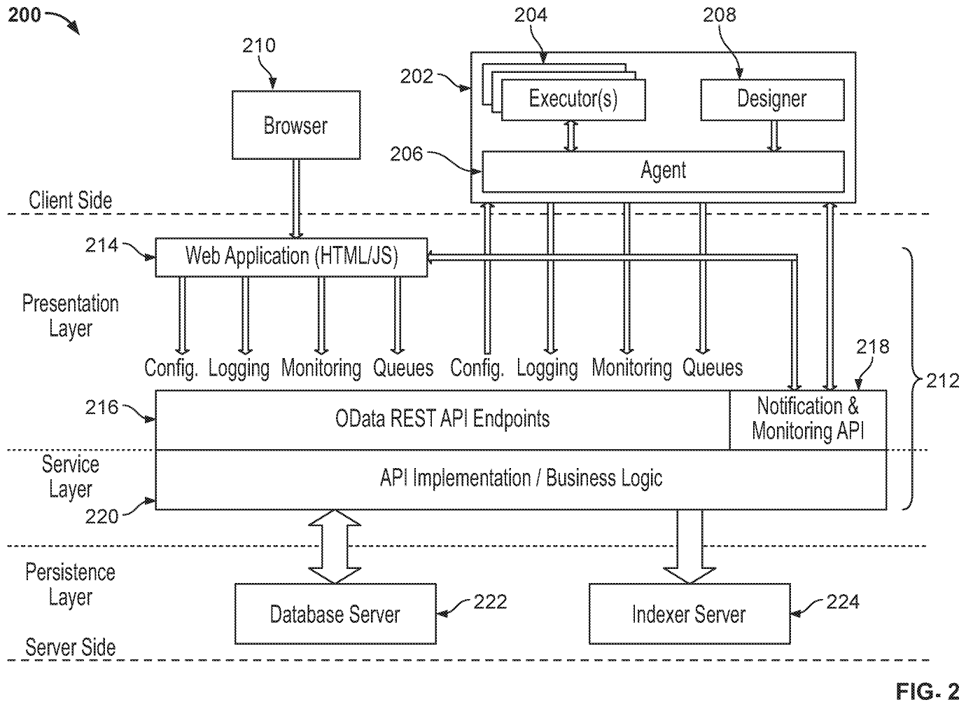

FIG. 2 shows an RPA system 200, in accordance with one or more embodiments. RPA system 200 may be, or may be part of, RPA system 100 of FIG. 1. It should be noted that the “client side”, the “server side”, or both, may include any desired number of computing systems without deviating from the scope of the invention.

As shown on the client side in this embodiment, computing system 202 includes one or more executors 204, agent 206, and designer 208. In other embodiments, designer 208 may not be running on the same computing system 202. An executor 204 (which may be a robot component as described above) runs a process and, in some embodiments, multiple business processes may run simultaneously. In this example, agent 206 (e.g., a Windows® service) is the single point of contact for managing executors 204.

In some embodiments, a robot represents an association between a machine name and a username. A robot may manage multiple executors at the same time. On computing systems that support multiple interactive sessions running simultaneously (e.g., Windows® Server 2012), multiple robots may be running at the same time (e.g., a high density (HD) environment), each in a separate Windows® session using a unique username.

Agent 206 is also responsible for sending the status of the robot (e.g., periodically sending a “heartbeat” message indicating that the robot is still functioning) and downloading the required version of the package to be executed. The communication between agent 206 and conductor 212 is initiated by agent 206 in some embodiments. In the example of a notification scenario, agent 206 may open a WebSocket channel that is later used by conductor 212 to send commands to the robot (e.g., start, stop, etc.).

As shown on the server side in this embodiment, a presentation layer comprises web application 214, Open Data Protocol (OData) Representative State Transfer (REST) Application Programming Interface (API) endpoints 216 and notification and monitoring API 218. A service layer on the server side includes API implementation/business logic 220. A persistence layer on the server side includes database server 222 and indexer server 224. Conductor 212 includes web application 214, OData REST API endpoints 216, notification and monitoring API 218, and API implementation/business logic 220.

In various embodiments, most actions that a user performs in the interface of conductor 212 (e.g., via browser 210) are performed by calling various APIs. Such actions may include, but are not limited to, starting jobs on robots, adding/removing data in queues, scheduling jobs to run unattended, and so on. Web application 214 is the visual layer of the server platform. In this embodiment, web application 214 uses Hypertext Markup Language (HTML) and JavaScript (JS). However, any desired markup languages, script languages, or any other formats may be used without deviating from the scope of the invention. The user interacts with web pages from web application 214 via browser 210 in this embodiment in order to perform various actions to control conductor 212. For instance, the user may create robot groups, assign packages to the robots, analyze logs per robot and/or per process, start and stop robots, etc.

In addition to web application 214, conductor 212 also includes a service layer that exposes OData REST API endpoints 216 (or other endpoints may be implemented without deviating from the scope of the invention). The REST API is consumed by both web application 214 and agent 206. Agent 206 is the supervisor of one or more robots on the client computer in this exemplary configuration.

The REST API in this embodiment covers configuration, logging, monitoring, and queueing functionality. The configuration REST endpoints may be used to define and configure application users, permissions, robots, assets, releases, and environments in some embodiments. Logging REST endpoints may be useful for logging different information, such as errors, explicit messages sent by the robots, and other environment-specific information, for example. Deployment REST endpoints may be used by the robots to query the package version that should be executed if the start job command is used in conductor 212. Queueing REST endpoints may be responsible for queues and queue item management, such as adding data to a queue, obtaining a transaction from the queue, setting the status of a transaction, etc. Monitoring REST endpoints monitor web application 214 and agent 206. Notification and monitoring API 218 may be REST endpoints that are used for registering agent 206, delivering configuration settings to agent 206, and for sending/receiving notifications from the server and agent 206. Notification and monitoring API 218 may also use WebSocket communication in some embodiments.

The persistence layer on the server side includes a pair of servers in this illustrative embodiment—database server 222 (e.g., a SQL server) and indexer server 224. Database server 222 in this embodiment stores the configurations of the robots, robot groups, associated processes, users, roles, schedules, etc. This information is managed through web application 214 in some embodiments. Database server 222 may also manage queues and queue items. In some embodiments, database server 222 may store messages logged by the robots (in addition to or in lieu of indexer server 224). Indexer server 224, which is optional in some embodiments, stores and indexes the information logged by the robots. In certain embodiments, indexer server 224 may be disabled through configuration settings. In some embodiments, indexer server 224 uses ElasticSearch®, which is an open source project full-text search engine. Messages logged by robots (e.g., using activities like log message or write line) may be sent through the logging REST endpoint(s) to indexer server 224, where they are indexed for future utilization.

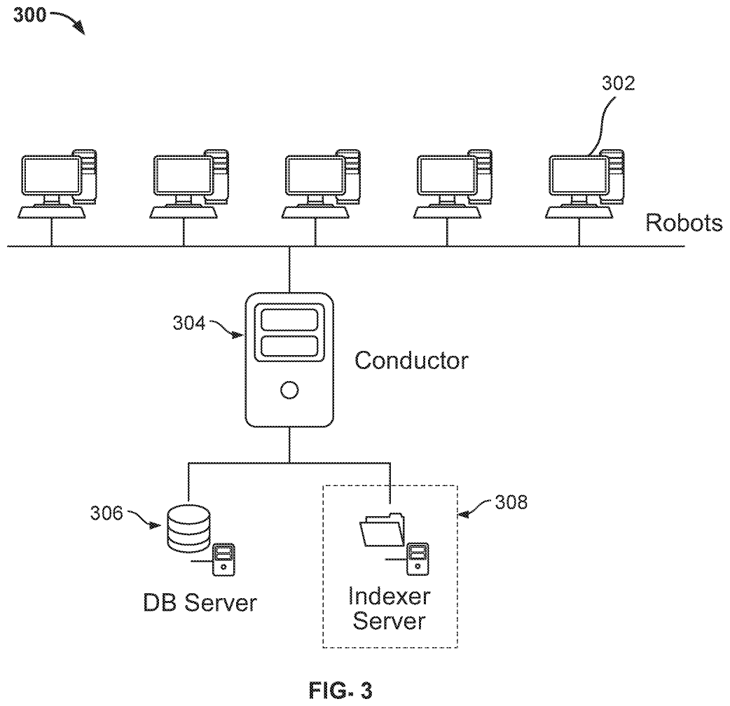

FIG. 3 is an architectural diagram illustrating a simplified deployment example of RPA system 300, in accordance with one or more embodiments. In some embodiments, RPA system 300 may be, or may include, RPA systems 100 and/or 200 of FIGS. 1 and 2, respectively. RPA system 300 includes multiple client computing systems 302 running robots. Computing systems 302 are able to communicate with a conductor computing system 304 via a web application running thereon. Conductor computing system 304, in turn, communicates with database server 306 and an optional indexer server 308. With respect to FIGS. 2 and 3, it should be noted that while a web application is used in these embodiments, any suitable client/server software may be used without deviating from the scope of the invention. For instance, the conductor may run a server-side application that communicates with non-web-based client software applications on the client computing systems.

In one embodiment, RPA system 100 of FIG. 1, RPA system 200 of FIG. 2, and/or RPA system 300 of Figure may be implemented for cloud-based management of RPA robots. Such cloud-based management of RPA robots enables RPA to be provided as Software as a Service (SaaS). Accordingly, conductor 104 of FIG. 1, conductor 212 of FIG. 2, and/or conductor 304 of FIG. 3 is implemented in the cloud for cloud-based management of RPA robots to, e.g., create RPA robots, provision RPA robots, schedule tasks on RPA robots, decommission RPA robots, or effectuate any other orchestration task for managing RPA robots.

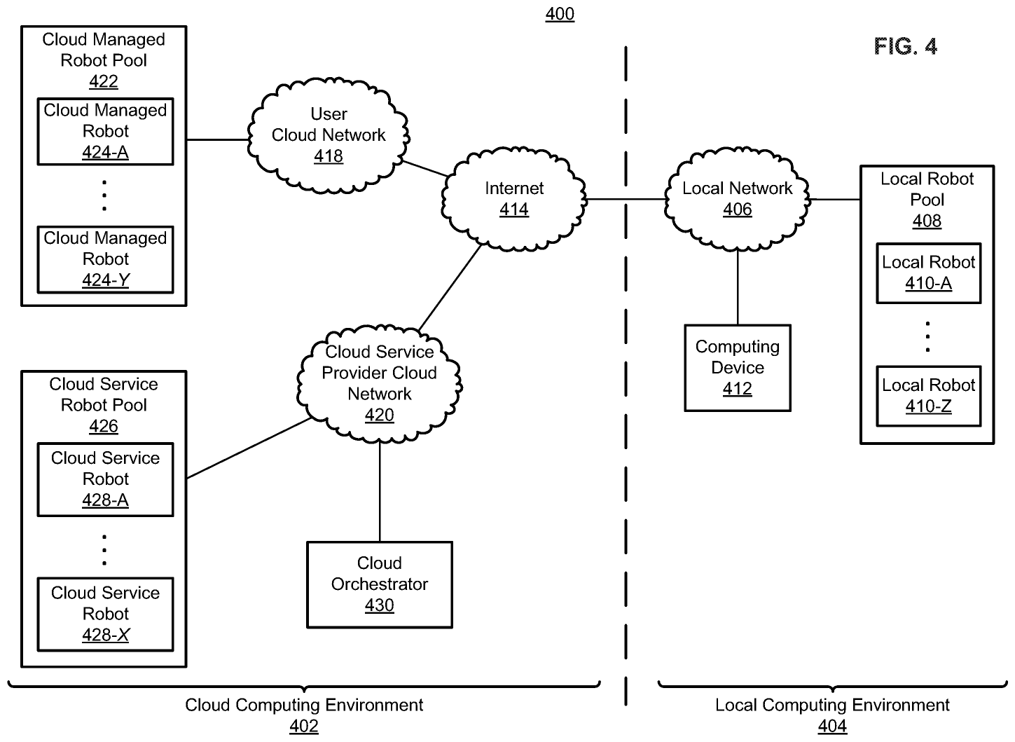

FIG. 4 illustrates an architectural diagram of a cloud RPA system 400 for implementing cloud-based management of RPA robots, in accordance with one or more embodiments. Cloud RPA system 400 comprises a cloud computing environment 402 and a local computing environment 404. Local computing environment 404 represents a local network architecture of a user or any other entity or entities, such as, e.g., a company, a corporation, etc. Local computing environment 404 comprises local network 406. Cloud computing environment 402 represents a cloud computing network architecture that provides services or processing of workloads remote from the user at local computing environment 404. Cloud computing environment 402 comprises various cloud networks, including internet 414, user cloud network 418 representing a cloud network managed (or controlled) by the user and hosted by a cloud platform provider, and a cloud service provider cloud network 420 representing a cloud network managed by a cloud service provider and hosted by a cloud platform provider. The cloud service provider is an entity that provides services (e.g., RPA) via the cloud. The cloud platform provider is an entity that maintains cloud computing infrastructure. Local network 406 of local computing environment 404 is communicatively coupled to internet 414 of cloud computing environment 402 to facilitate communication between local computing environment 404 and cloud computing environment 402.

As shown in FIG. 4, a cloud orchestrator 430 is implemented in cloud computing environment 402 to enable cloud-based management of RPA robots. In particular, cloud orchestrator 430 is managed by a cloud service provider and hosted in cloud service provider cloud network 420 within cloud computing environment 402. In one embodiment, the cloud service provider provides RPA to the user in local computing environment 404.

Cloud orchestrator 430 manages RPA robots in cloud computing environment 402. In particular, the user interacts with computing device 412 in local computing environment 404 to transmit instructions for managing RPA robots to cloud orchestrator 430 in cloud computing environment 402. Alternatively, the user interacts with computing device 412 in local computing environment 404 to set a schedule on cloud orchestrator 430 to automatically transmit instructions on behalf of the user for managing RPA robots. Exemplary instructions for managing RPA robots include instructions for creating RPA robots, provisioning RPA robots, scheduling a task on RPA robots (e.g., schedule a time for performing the task and a type of robot to perform the task), decommissioning RPA robots, or any other orchestration instructions for RPA robots. In response to receiving the instructions, cloud orchestrator 430 effectuates the instructions by, e.g., creating the RPA robots, provisioning the RPA robots, scheduling the task of the RPA robot, decommissioning the RPA robots, etc. In one embodiment, cloud orchestrator 430 may be similar to conductor 104 of FIG. 1, conductor 212 of FIG. 2, or conductor 304 of FIG. 3, but implemented in cloud service provider cloud network 420 within cloud computing environment 402.

The RPA robots managed by cloud orchestrator 430 may include a pool of cloud robots that are deployed and maintained within cloud computing environment 402. Such cloud robots may include one or more cloud service robots 428-A, . . . , 428-X (hereinafter collectively referred to as cloud service robots 428) of cloud service robot pool 426 and one or more cloud managed robots 424-A, . . . , 424-Y (hereinafter collectively referred to as cloud managed robots 424) of cloud managed robot pool 422. Such cloud robots perform (i.e., process) tasks in cloud computing environment 402 and transmit results of the tasks to the user in local computing environment 404. Additionally or alternatively, the RPA robots managed by cloud orchestrator 430 may include one or more local robots 410-A, . . . , 410-Z (hereinafter collectively referred to as local robots 410) of local robot pool 408.

Cloud service robots 428 are maintained by the cloud service provider in cloud service provider cloud network 420 for performing RPA tasks in cloud computing environment 402 for the user in local network environment 404. Cloud service robots 428 are created upon request by the user sending instructions from computing device 412 to cloud orchestrator 430. Upon creation, cloud service robots 428 enter into a standby mode while waiting to perform a task (or workflow). While in standby mode, the cost for running the cloud service robots 428 is minimized or otherwise reduced. Tasks are scheduled on cloud service robots 428 by the user sending instructions from computing device 412 to cloud orchestrator 430. The instructions for scheduling tasks defines the time for performing the task and a type of robot for performing the task. Cloud service robots 428 wake up from standby mode to perform the task and return to standby mode once the task is complete. Accordingly, cloud service robots 428 perform the tasks on cloud service provider cloud network 420 for the user in local computing environment 404.

Cloud managed robots 424 are maintained by the user in a user cloud network 418 for performing RPA tasks in cloud computing environment 402 for the user in local network environment 404. Cloud managed robots 424 are similar in capability to cloud service robots 428 and are also hosted in cloud computing environment 402. However, user cloud network 418, upon which cloud managed robots 424 are hosted, is managed by the user while cloud service provider cloud network 420, upon which cloud service robots 428 are hosted, is managed by the cloud service provider and hosted by the cloud platform provider. Cloud orchestrator 430 manages cloud managed robots 424 by establishing a connection between cloud service provider cloud network 420 and user cloud network 418. User cloud network 418 may be established by the user utilizing cloud provider technology to tunnel back to local network 406. The user can establish a dedicated network connection from local network 406 to cloud service provider cloud network 420. Connectivity is typically in the form of, e.g., an any-to-any (e.g., internet protocol virtual private network) network, a point-to-point Ethernet network, or a virtual cross-connection through a connectivity provider at a co-location facility. These connections do not go over the public Internet. This offers more reliability, faster speeds, consistent latencies, and higher security than typical connections over the Internet. User cloud network 418 continues to be fully controlled and managed by the user, thereby providing stringent control over data to the user.

Once the connection between cloud service provider cloud network 420 and user cloud network 418 has been established, cloud managed robots 424 are created upon request by the user interacting with cloud orchestrator 430 via computing device 412. Cloud managed robots 424 are created on user cloud network 418. Accordingly, cloud managed robots 424 perform the tasks on user cloud network 418 for the user in local computing environment 404. Algorithms may be applied to maximize the utilization of the robots in cloud managed robot pool 422 and to reduce operating costs for the user.

Local robots 410 are maintained by the user in local network 406 for performing RPA tasks for the user in local network environment 404. Local network 406 is controlled or otherwise managed by the user. Cloud Orchestrator 430 maintains a connection to local robots 410 through standard HTTPS connectivity.

RPA system 100 of FIG. 1, RPA system 200 of FIG. 2, RPA system 300 of FIG. 3, and/or cloud RPA system 400 of FIG. 4 may be implemented by an RPA provider for implementing RPA for RPA customers, such as, e.g., companies, organizations, or other entities. Embodiments described herein provide for quantifying usage of RPA related resources by RPA customers. Such quantified usage of RPA related resources may be utilized for various different applications. In one example, such quantified usage of RPA related resources may be utilized to provide for consumption based billing to enable RPA providers to bill RPA customers based on their actual usage of RPA resources. In another example, such quantified usage of RPA related resources may be utilized to calculate different metrics of interest, such as, e.g., return on investment for implementing RPA.

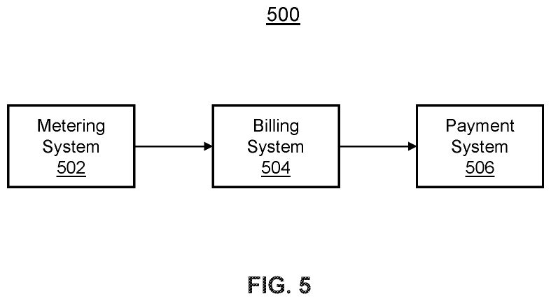

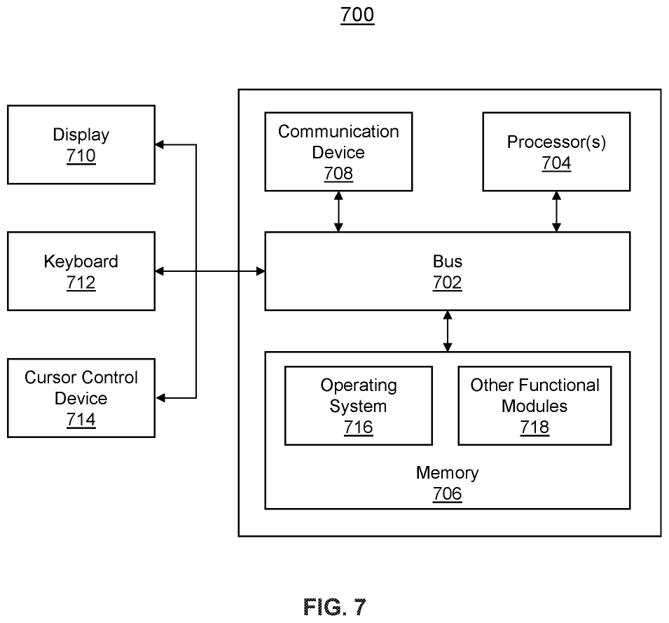

FIG. 5 shows a system 500 for consumption based billing for RPA, in accordance with one or more embodiments. System 500 includes a metering system 502, a billing system 504, and a payment system 506, which may be implemented by one or more suitable computing devices, such as, e.g., computing system 700 of FIG. 7. Metering system 502, billing system 504, and/or payment system 506 may be implemented in a cloud computing environment (e.g., in cloud computing environment 402 of FIG. 4) or in a local computing environment (e.g., in local computing environment 404 of FIG. 4).

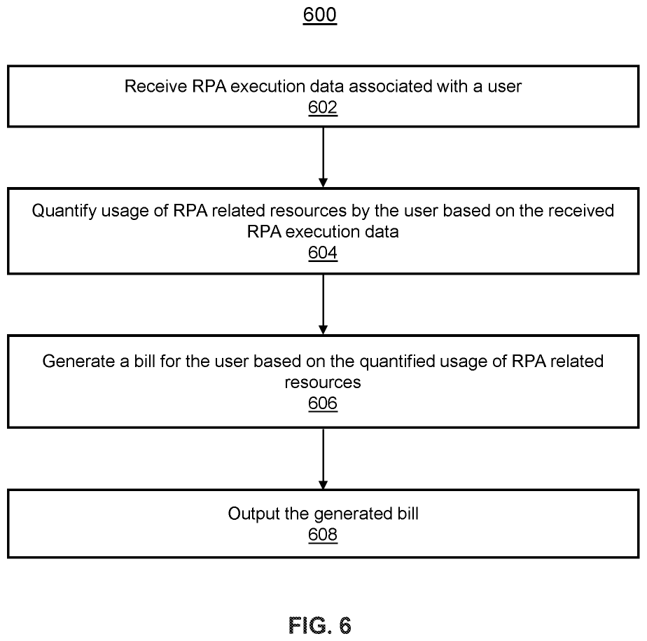

FIG. 6 shows a method 600 for consumption based billing for RPA, in accordance with one or more embodiments. Method 600 will be described together with system 500 of FIG. 5. Steps of method 600 may be performed by, e.g., certain components of system 500 of FIG. 5 or any other suitable computing device or devices, such as, e.g., computing system 700 of FIG. 7.

At step 602, RPA execution data associated with a user is received. In one example, the RPA execution data may be received by metering system 502 of FIG. 5. The user may be an RPA customer (e.g., a company, an organization, etc.) or any other user. The RPA execution data may be any data associated with the execution of RPA workflows by one or more RPA robots. In one embodiment, the RPA execution data may comprise an event log of one or more instances of execution of an RPA workflow. The event log identifies events corresponding to the execution of activities of the RPA workflow at a particular time and during a particular instance of execution of the RPA workflow. In another embodiment, the RPA execution data comprises data relating to the usage of RPA related resources. Such RPA related resources may include, e.g., computing resources, network resources, resources relating to RPA robots, RPA related services or tasks, metrics relating to RPA execution, or any resource used during the execution of RPA workflows by RPA robots. Other forms of RPA execution data are also contemplated.

In one embodiment, the data relating to RPA related services or tasks may include data relating to first-party RPA related services or tasks owned by an RPA provider implementing the RPA or third-party RPA related services or tasks not owned by the RPA provider (e.g., licensed RPA related services or tasks). In one example, the data relating to RPA related services or tasks includes a number of invocations of the RPA related services or tasks or an execution time of the RPA related services or tasks. For example, the number of invocations of the RPA related services or tasks may be the number of times OCR (optical character recognition) is performed (e.g., for each document or for each page). Other exemplary RPA related services or tasks include NPL (natural language processing, call center RPA agents, etc.).

The RPA execution data may be received from RPA robots (e.g., robots 106 of FIG. 1, robots 302 of FIG. 3, or robots 410, 422, or 426 of FIG. 4) or an RPA orchestrator (e.g., conductor 104 of FIG. 1, conductor 212 of FIG. 2, conductor 304 of FIG. 3, or cloud orchestrator 430 of FIG. 4). The RPA robots and/or RPA orchestrator may be implemented in a cloud computing environment (e.g., cloud computing environment 402 of FIG. 4). The RPA execution data may be directly received from the RPA robots or RPA orchestrator or may be received by loading previously stored RPA execution data from a storage or memory (e.g., memory 706 of FIG. 7) of a computer system or by receiving RPA execution data transmitted from a remote computer system.

At step 604, usage of RPA related resources by the user is quantified based on the received RPA execution data. In one example, the usage of RPA related resources is quantified by metering system 502 of FIG. 5. The RPA related resources may include any resource used for execution of RPA workflows by RPA robots. The usage of RPA related resources may be quantified by calculating one or more parameters based on the received RPA execution data. The parameters may be any parameters representing the usage of RPA related resources by the user. In one embodiment, the parameters may include parameters relating to the usage of resources for the execution of RPA workflows by RPA robots. For example, the parameters may include parameters relating to the usage of computing resources, such as, e.g., compute cycle, CPU (central processing unit) usage, RAM (random access memory) usage, storage parameters (e.g., parameters representing data transfer and length of operations per collection cycle on a storage volume), API (application programming interface) usage for RPA services, data usage (e.g., in a data center or call center), etc. In another example, the parameters may include parameters relating to the usage of network resources, such as, e.g., the amount of data sent and received on a network interface, etc. In another example, the parameters may include parameters relating to the usage of RPA services or tasks, such as, e.g., the number of RPA robots utilized, the type of RPA robots utilized, the execution time of each RPA robot utilized, the number of times an RPA service or task is performed (e.g., the number of times an RPA service or task (first-party or third-party) is invoked, the number of pages on which the RPA service is performed, the type of document on which the RPA service is performed, execution time of an RPA service), etc.

In one embodiment, the parameters may include metrics relating to RPA execution. The metrics may comprise metrics representing performance of RPA and/or metrics representing an expected performance of RPA. For example, the metrics representing performance of RPA may include calculated costs saved, calculated time saved, or calculated key performance indicators related to the operational activity of RPA robots and the metrics representing an expected performance of RPA may include a predicted costs saved, a predicted time saved, or predicted key performance indicators. The costs saved may be determined as the product of the time saved (e.g., in hours) by automating a workflow and the cost (e.g., per hour) of a user to manually perform the workflow. The number of robot hours metric may be determined as the total execution time of RPA robots. In one embodiment, the metrics relating to RPA execution may be based on a comparison of the metrics representing performance of RPA and the metrics representing an expected performance of RPA.

At step 606, a bill is generated for the user based on the quantified usage of RPA related resources. In one example, the bill is generated by billing system 504 of FIG. 5. The bill may be generated based on the quantified usage of RPA related resources, as quantified by the calculated parameters, according to a billing model. In one embodiment, the billing model may be any service agreement between the RPA provider and the user defining a negotiated rate plan. The billing model may be, for example, a consumption based billing model agreed upon by the user and an RPA provider that provides the RPA related resources.

In one embodiment, the billing model comprises a commitment plus monthly overage model. In this embodiment, the user is charged a fixed amount each month (or any other suitable time period) for access to a fixed amount of RPA related resources. If the calculated parameters quantifying the usage of RPA related resources exceed the fixed amount of RPA related resources, the user is also charged an additional amount. In one embodiment, the additional amount may be an additional amount for each predetermined amount of the RPA related resources that exceeds the fixed amount. The predetermined amount of the RPA related resources may be, for example, a predetermined number of RPA robots, a predetermined amount of memory, etc., depending on the RPA related resource. For example, the user may be charged a fixed amount for using a fixed number of RPA robots, plus an additional amount for each additional RPA robot utilized over the fixed number of RPA robots.

In another embodiment, the billing model comprises a monthly variable billing model. In this embodiment, the user is charged an amount each month (or any other suitable time period) based on (e.g., proportional to) the calculated parameters quantifying the usage of RPA related resources. For example, the user may be charged for the total number of RPA robots utilized each month. In another example, the user may be charged for each performance of an RPA service, such as, e.g., the performance of an RPA document processing service on each document, each time a document is scanned, each time OCR is performed, each time RPA algorithms are performed, etc. Other billing models are also contemplated.

In another embodiment, the bill is generated based on the metrics relating to RPA execution. For example, the bill may be based on a metric representing performance of RPA (e.g., calculated costs saved or time saved). In another example, the bill may be based on a comparison between a metric representing performance of RPA and a metric representing an expected performance of RPA (e.g., a comparison between a calculated costs saved or time saved and a predicted costs saved or time saved).

In another embodiment, the bill is generated based on the whether an invoked RPA related service or task is a first-party RPA related service or task or a third-party RPA related service or task. For example, invocation of a third-party RPA related service or task may incur a different fee than a first-party RPA related service or task.

At step 608, the generated bill is output. The generated bill may be output by, for example, displaying the generated bill on a display device of a computer system (e.g., display 710 of FIG. 7) or by storing the generated bill on a memory or storage of a computer system (e.g., memory 706 of FIG. 7).

In one embodiment, the generated bill is output by transmitting the generated bill to the user with a prompt for payment of the generated bill. Payment of the generated bill may be received at the prompt from the user. In one embodiment, the payment of the generated bill may be automatically performed by, e.g., automatically deducting the payment a user's account. The payment may be in the form of a prepaid payment where the user pays for the utilization of RPA related resources prior to use or a postpaid payment where the user pays for the utilization of RPA related resources after use. In one example, the generated bill is transmitted to the user and/or payment of the generated bill is received by payment system 506 of FIG. 5.

Advantageously, embodiments described herein provide for quantifying usage of RPA related resources to thereby enable consumption based billing of RPA. Such consumption based billing allows RPA customers to pay for RPA based on their consumption of RPA related resources, which creates a low barrier to entry for RPA as RPA customers may implement RPA without having to commit to costly fixed pricing models.

FIG. 7 is a block diagram illustrating a computing system 700 configured to execute the methods, workflows, and processes described herein, including method 600 of FIG. 6, according to an embodiment of the present invention. In some embodiments, computing system 700 may be one or more of the computing systems depicted and/or described herein. Computing system 700 includes a bus 702 or other communication mechanism for communicating information, and processor(s) 704 coupled to bus 702 for processing information. Processor(s) 704 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 704 may also have multiple processing cores, and at least some of the cores may be configured to perform specific functions. Multi-parallel processing may be used in some embodiments.

Computing system 700 further includes a memory 706 for storing information and instructions to be executed by processor(s) 704. Memory 706 can be comprised of any combination of Random Access Memory (RAM), Read Only Memory (ROM), flash memory, cache, static storage such as a magnetic or optical disk, or any other types of non-transitory computer-readable media or combinations thereof. Non-transitory computer-readable media may be any available media that can be accessed by processor(s) 704 and may include volatile media, non-volatile media, or both. The media may also be removable, non-removable, or both.

Additionally, computing system 700 includes a communication device 708, such as a transceiver, to provide access to a communications network via a wireless and/or wired connection according to any currently existing or future-implemented communications standard and/or protocol.

Processor(s) 704 are further coupled via bus 702 to a display 710 that is suitable for displaying information to a user. Display 710 may also be configured as a touch display and/or any suitable haptic I/O device.

A keyboard 712 and a cursor control device 714, such as a computer mouse, a touchpad, etc., are further coupled to bus 702 to enable a user to interface with computing system. However, in certain embodiments, a physical keyboard and mouse may not be present, and the user may interact with the device solely through display 710 and/or a touchpad (not shown). Any type and combination of input devices may be used as a matter of design choice. In certain embodiments, no physical input device and/or display is present. For instance, the user may interact with computing system 700 remotely via another computing system in communication therewith, or computing system 700 may operate autonomously.

Memory 706 stores software modules that provide functionality when executed by processor(s) 704. The modules include an operating system 716 for computing system 700 and one or more additional functional modules 718 configured to perform all or part of the processes described herein or derivatives thereof.

One skilled in the art will appreciate that a “system” could be embodied as a server, an embedded computing system, a personal computer, a console, a personal digital assistant (PDA), a cell phone, a tablet computing device, a quantum computing system, or any other suitable computing device, or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like. A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention. Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The foregoing merely illustrates the principles of the disclosure. It will thus be appreciated that those skilled in the art will be able to devise various arrangements that, although not explicitly described or shown herein, embody the principles of the disclosure and are included within its spirit and scope. Furthermore, all examples and conditional language recited herein are principally intended to be only for pedagogical purposes to aid the reader in understanding the principles of the disclosure and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future.

1. A computer implemented method comprising:
quantifying usage of RPA (robotic process automation) related resources by a user based on RPA execution data associated with the user;
generating a bill for the user based on the quantified usage of RPA related resources; and
outputting the generated bill.

2. The computer implemented method of claim 1, wherein quantifying usage of RPA (robotic process automation) related resources by a user based on RPA execution data associated with the user comprises:
calculating one or more parameters representing the usage of RPA related resources based on the RPA execution data.

3. The computer implemented method of claim 2, wherein the one or more parameters are based on at least one of a compute cycle, CPU (central processing unit) usage, RAM (random access memory usage), storage parameters, or API (application programming interface) usage for RPA services.

4. The computer implemented method of claim 2, wherein the one or more parameters are based on data sent and received on a network interface.

5. The computer implemented method of claim 2, wherein the one or more parameters are based on at least one of a number of RPA robots utilized, a type of the RPA robots utilized, an execution of the RPA robots utilized, a number of times an RPA service or task is performed, or metrics evaluating RPA execution.

6. The computer implemented method of claim 2, wherein the one or more parameters includes whether an RPA service or task is a third-party RPA service or task.

7. The computer implemented method of claim 1, wherein generating a bill for the user based on the quantified usage of RPA related resources comprises:
generating the bill for the user based on a billing model.

8. The computer implemented method of claim 1, wherein the RPA execution data associated with the user is from at least one of an RPA robot or an RPA orchestrator.

9. The computer implemented method of claim 8 , wherein the at least one of the RPA robot or the RPA orchestrator are implemented in a cloud computing environment.

10. An apparatus comprising:
a memory storing computer instructions; and
at least one processor configured to execute the computer instructions, the computer instructions configured to cause the at least one processor to perform operations of:
quantifying usage of RPA (robotic process automation) related resources by a user based on RPA execution data associated with the user;
generating a bill for the user based on the quantified usage of RPA related resources; and
outputting the generated bill.

11. The apparatus of claim 10, wherein quantifying usage of RPA (robotic process automation) related resources by a user based on RPA execution data associated with the user comprises:
calculating one or more parameters representing the usage of RPA related resources based on the RPA execution data, wherein the one or more parameters are based on at least one of a compute cycle, CPU (central processing unit) usage, RAM (random access memory usage), storage parameters, or API (application programming interface) usage for RPA services.

12. The apparatus of claim 10, wherein quantifying usage of RPA (robotic process automation) related resources by a user based on RPA execution data associated with the user comprises:
calculating one or more parameters representing the usage of RPA related resources based on the RPA execution data, wherein the one or more parameters are based on data sent and received on a network interface.

13. The apparatus of claim 10, wherein quantifying usage of RPA (robotic process automation) related resources by a user based on RPA execution data associated with the user comprises:
calculating one or more parameters representing the usage of RPA related resources based on the RPA execution data, wherein the one or more parameters are based on at least one of a number of RPA robots utilized, a type of the RPA robots utilized, an execution of the RPA robots utilized, a number of times an RPA service or task is performed, or metrics evaluating RPA execution.

14. The apparatus of claim 10, wherein quantifying usage of RPA (robotic process automation) related resources by a user based on RPA execution data associated with the user comprises:
calculating one or more parameters representing the usage of RPA related resources based on the RPA execution data, wherein the one or more parameters includes whether an RPA service or task is a third-party RPA service or task.

15. The apparatus of claim 10, wherein generating a bill for the user based on the quantified usage of RPA related resources comprises:
generating the bill for the user based on a billing model.

16. A computer program embodied on a non-transitory computer-readable medium, the computer program configured to cause at least one processor to perform operations comprising:
quantifying usage of RPA (robotic process automation) related resources by a user based on RPA execution data associated with the user;
generating a bill for the user based on the quantified usage of RPA related resources; and
outputting the generated bill.

17. The computer program of claim 16, wherein quantifying usage of RPA (robotic process automation) related resources by a user based on RPA execution data associated with the user comprises:
calculating one or more parameters representing the usage of RPA related resources based on the RPA execution data, wherein the one or more parameters are based on at least one of a compute cycle, CPU (central processing unit) usage, RAM (random access memory usage), storage parameters, or API (application programming interface) usage for RPA services.

18. The computer program of claim 16, wherein quantifying usage of RPA (robotic process automation) related resources by a user based on RPA execution data associated with the user comprises:
calculating one or more parameters representing the usage of RPA related resources based on the RPA execution data, wherein the one or more parameters are based on data sent and received on a network interface.

19. The computer program of claim 16, wherein quantifying usage of RPA (robotic process automation) related resources by a user based on RPA execution data associated with the user comprises:
calculating one or more parameters representing the usage of RPA related resources based on the RPA execution data, wherein the one or more parameters are based on at least one of a number of RPA robots utilized, a type of the RPA robots utilized, an execution of the RPA robots utilized, a number of times an RPA service or task is performed, or metrics evaluating RPA execution.

20. The computer program of claim 16, wherein quantifying usage of RPA (robotic process automation) related resources by a user based on RPA execution data associated with the user comprises:
calculating one or more parameters representing the usage of RPA related resources based on the RPA execution data, wherein the one or more parameters includes whether an RPA service or task is a third-party RPA service or task.

21. The computer program of claim 16, wherein the RPA execution data associated with the user is from at least one of an RPA robot or an RPA orchestrator.

22. The computer program of claim 21, wherein the at least one of the RPA robot or the RPA orchestrator are implemented in a cloud computing environment.

23. The computer implemented method of claim 1, wherein the quantifying, the generating, and the outputting are performed by one or more computing devices implemented in a cloud computing system.

24. The apparatus of claim 10, wherein the apparatus is implemented in a cloud computing system.

25. The computer program of claim 16, wherein the at least one processor is implemented in one or more computing devices and the one or more computing devices are implemented in a cloud computing system.
